(19) United States
(12) Patent Application Publication
(10) Pub. No.: US 2025/0055519 A1
(43) Pub. Date: Feb. 13, 2025

(54) SUB-BAND NON-OVERLAPPING FULL DUPLEX PATTERN WITH ANTENNA SWITCHING

(71) Applicant: Nokia Technologies Oy, Espoo (FI)

(72) Inventors: Jing Yuan SUN, Beijing (CN); Claudio ROSA, Aalborg (DK); Guillermo POCOVI, Aalborg (DK); Erika PORTELA LOPES DE ALMEIDA, Aalborg (DK); Youngsoo YUK, Seoul (KR); Nhat-Quang NHAN, Massy (FR)

(21) Appl. No.: 18/785,930

(22) Filed: Jul. 26, 2024

(30) Foreign Application Priority Data
Aug. 10, 2023 (WO) PCT/CN2023/112389

(51) Int. Cl. H04B 7/06; H04B 7/08; H04W 28/18

(52) U.S. Cl. CPC H04B 7/0602; H04B 7/0805; H04W 28/18

(57) ABSTRACT

Example embodiments of the present disclosure relate to methods, devices, apparatuses and computer readable storage medium of configuration of sub-band non-overlapping full duplex (SBFD) with antenna switching. In a method, a first apparatus determines information related to antenna switching by a second apparatus within a subset of SBFD patterns of a set of SBFD patterns. The first apparatus determines, at least based on the information related to the antenna switching, at least one time point for antenna switching

### FIELDS

Various example embodiments of the present disclosure generally relate to the field of telecommunication and in particular, to methods, devices, apparatuses and computer readable storage medium for sub-band non-overlapping full duplex (SBFD) pattern with antenna switching.

### BACKGROUND

In some communication systems such as fifth generation (5G) new radio (NR) system, various duplexing modes are supported. For example, frequency division duplexing (FDD) for paired bands and time division duplexing (TDD) for unpaired bands are supported. In TDD, the time domain resource is split between downlink (DL) and uplink (UL). Allocation of a limited time duration for the uplink in TDD may result in reduced coverage, increased latency, and reduced capacity. To address these challenges, SBFD such as simultaneous DL and UL transmission on different physical resource blocks (PRBs) or sub-bands within an unpaired wideband NR cell is proposed.

### SUMMARY

In a first aspect of the present disclosure, there is provided a first apparatus. The first apparatus comprises at least one processor; and at least one memory storing instructions that, when executed by the at least one processor, cause the first apparatus to: determine information related to antenna switching by a second apparatus within a subset of sub-band non-overlapping full duplex (SBFD) patterns of a set of SBFD patterns; and determine, at least based on the information related to the antenna switching, at least one time point for antenna switching.

In a second aspect of the present disclosure, there is provided a second apparatus. The second apparatus comprises at least one processor; and at least one memory storing instructions that, when executed by the at least one processor, cause the second apparatus to: determine a configuration of an antenna switching pattern corresponding to a set of sub-band non-overlapping full duplex (SBFD) patterns, the configuration indicating antenna switching within a subset of SBFD patterns of the set of SBFD patterns; and determine at least one time point for antenna switching by the second apparatus based on the configuration of the antenna switching pattern.

In a third aspect of the present disclosure, there is provided a method. The method comprises: determining, at a first apparatus, information related to antenna switching by a second apparatus within a subset of sub-band non-overlapping full duplex (SBFD) patterns of a set of SBFD patterns; and determining, at least based on the information related to the antenna switching, at least one time point for antenna switching.

In a fourth aspect of the present disclosure, there is provided a method. The method comprises: determining, at a second apparatus, a configuration of an antenna switching pattern corresponding to a set of sub-band non-overlapping full duplex (SBFD) patterns, the configuration indicating antenna switching by the second apparatus within a subset of SBFD patterns of the set of SBFD patterns; and determining at least one time point for antenna switching based on the configuration of the antenna switching pattern.

In a fifth aspect of the present disclosure, there is provided a first apparatus. The first apparatus comprises means for determining information related to antenna switching by a second apparatus within a subset of sub-band non-overlapping full duplex (SBFD) patterns of a set of SBFD patterns; and means for determining, at least based on the information related to the antenna switching, at least one time point for antenna switching.

In a sixth aspect of the present disclosure, there is provided a second apparatus. The second apparatus comprises means for determining a configuration of an antenna switching pattern corresponding to a set of sub-band non-overlapping full duplex (SBFD) patterns, the configuration indicating antenna switching by the second apparatus within a subset of SBFD patterns of the set of SBFD patterns; and means for determining at least one time point for antenna switching based on the configuration of the antenna switching pattern.

In a seventh aspect of the present disclosure, there is provided a computer readable medium. The computer readable medium comprises instructions stored thereon for causing an apparatus to perform at least the method according to the third aspect or the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRA WINGS

Some example embodiments will now be described with reference to the accompanying drawings, where:

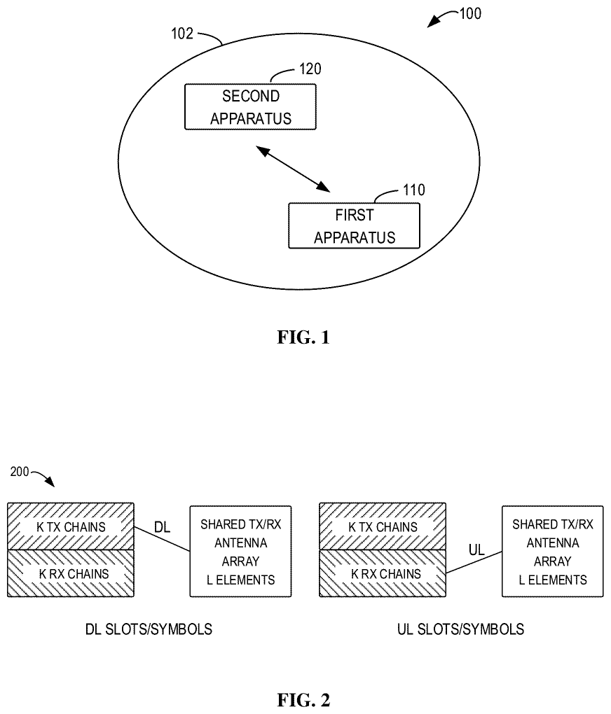

FIG. 1 illustrates an example communication environment in which example embodiments of the present disclosure can be implemented;

FIG. 2 illustrates an example diagram showing TDD with shared antenna array;

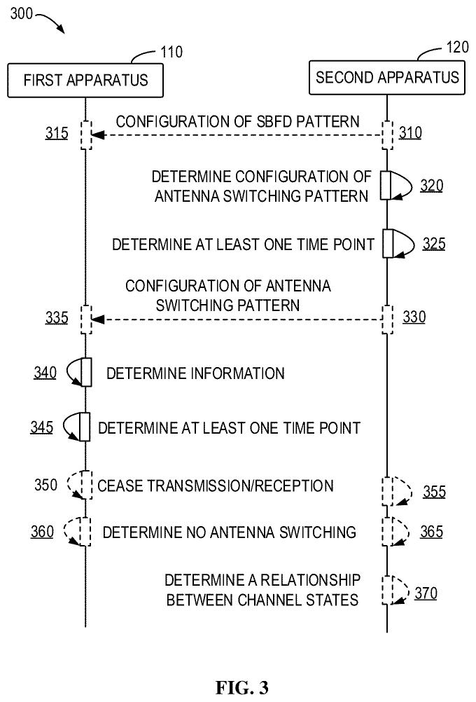

FIG. 3 illustrates a signaling diagram for SBFD with antenna switching according to some example embodiments of the present disclosure;

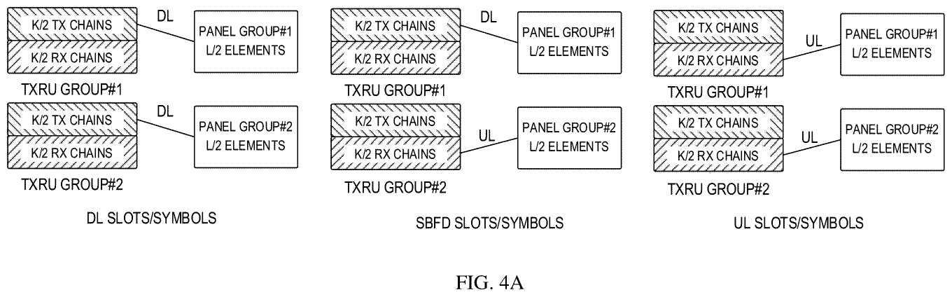

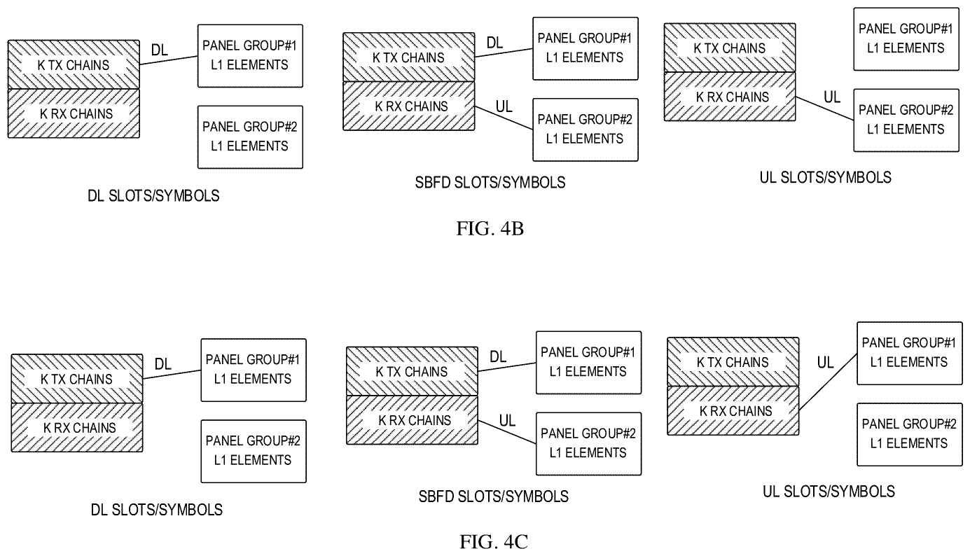

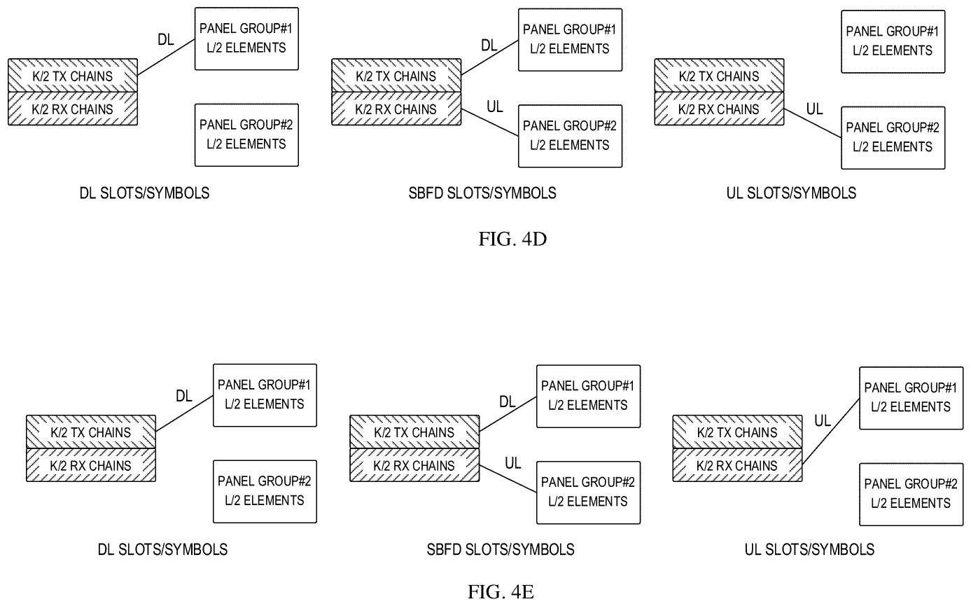

FIG. 4A-FIG. 4E illustrate example antenna and chain configuration for SBFD pattern according to some example embodiments of the present disclosure, respectively;

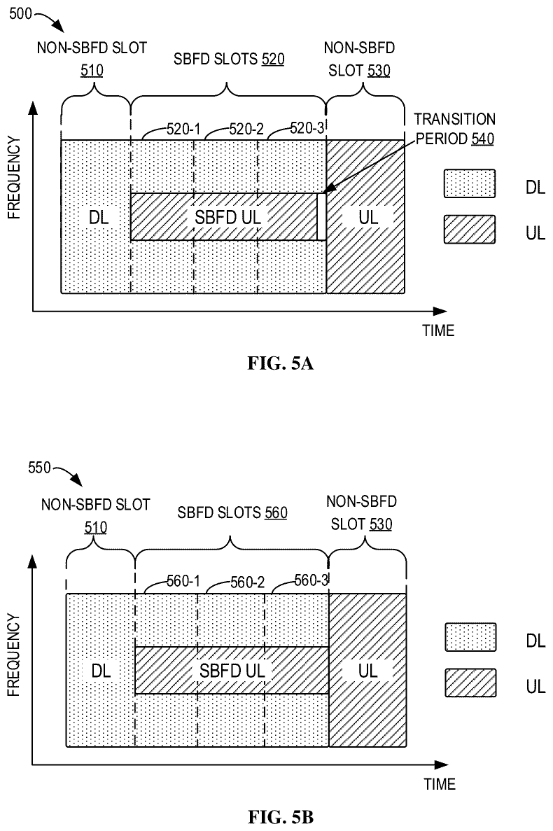

FIG. 5A and FIG. 5B illustrate example SBFD patterns according to some example embodiments of the present disclosure, respectively;

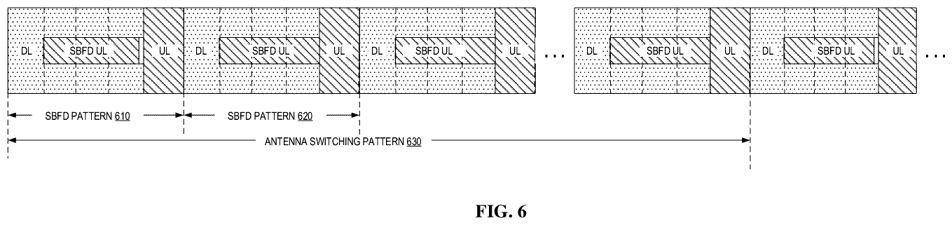

FIG. 6 illustrates an example antenna switching pattern according to some example embodiments of the present disclosure;

FIG. 7 illustrates an example process for determining an antenna switching within an SBFD pattern according to some example embodiments of the present disclosure;

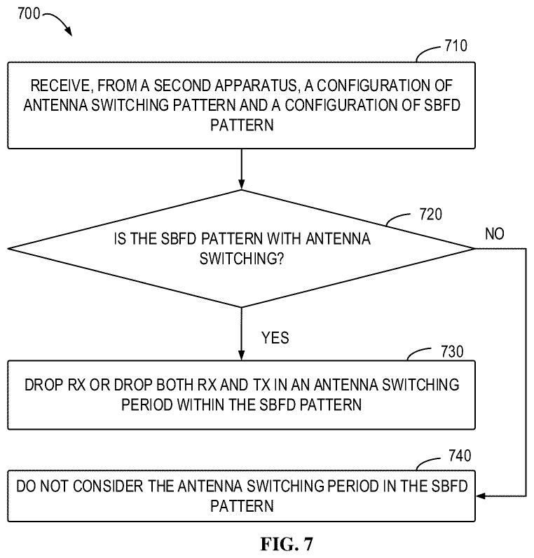

FIG. 8 illustrates a flowchart of a method implemented at a first apparatus according to some example embodiments of the present disclosure;

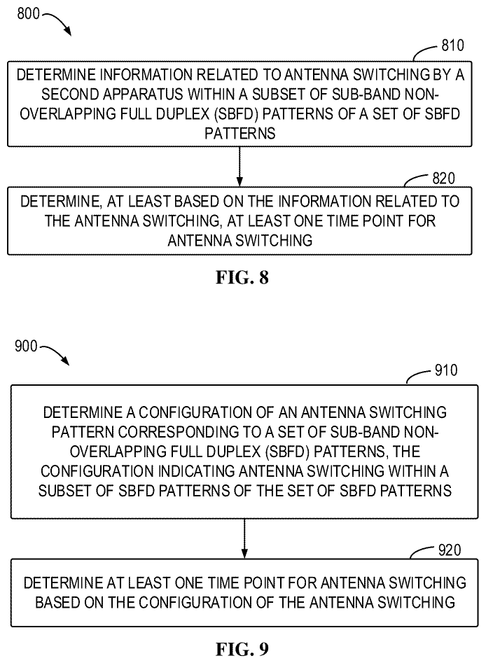

FIG. 9 illustrates a flowchart of a method implemented at a second apparatus according to some example embodiments of the present disclosure;

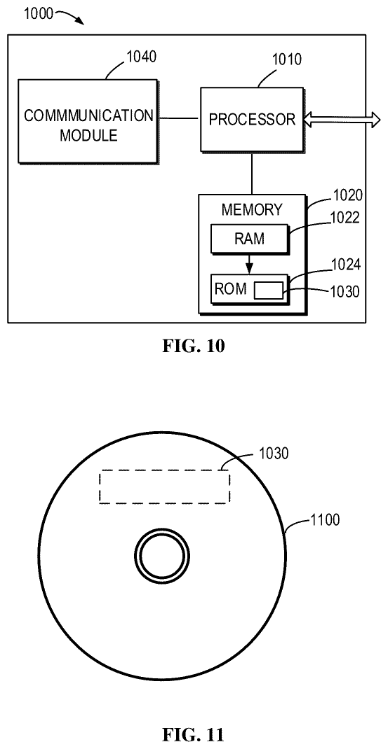

FIG. 10 illustrates a simplified block diagram of a device that is suitable for implementing example embodiments of the present disclosure; and

FIG. 11 illustrates a block diagram of an example computer readable medium in accordance with some example embodiments of the present disclosure.] Throughout the drawings, the same or similar reference numerals represent the same or similar element.

### DETAILED DESCRIPTION

Principle of the present disclosure will now be described with reference to some example embodiments. It is to be understood that these embodiments are described only for purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As briefly mentioned above, various duplexing modes such as FDD and TDD are supported in the communication networks. In TDD, the time domain resource is split between downlink (DL) and uplink (UL). Allocation of a limited time duration for the uplink in TDD may result in reduced coverage, increased latency, and reduced capacity.

In some mechanisms, as a possible enhancement on this limitation of the TDD operation, it may be worth studying the feasibility of allowing the simultaneous existence of downlink and uplink, such as full duplex, or more specifically, sub-band non-overlapping full duplex (SBFD) at the gNB side within a TDD band.

The new radio (NR) TDD specifications allow the dynamic or flexible allocation of downlink and uplink in time and cross link interference (CLI) handling and remote interference management (RIM) for NR. Nevertheless, further study may be required for CLI handling between the gNBs of the same or different operators to enable the dynamic or flexible TDD in commercial networks. The inter-gNB CLI may be due to either adjacent-channel CLI or co-channel-CLI, or both, depending on the deployment scenario. One of the problems not addressed is gNB-to-gNB CLI.

The feasibility and solutions of duplex evolution in the areas outlined above need to be identified to provide enhanced UL coverage, reduced latency, improved system capacity, and improved configuration flexibility for NR TDD operations in unpaired spectrum. In addition, the regulatory aspects need to be examined for deploying identified duplex enhancements in TDD unpaired spectrum considering potential constraints.

In some mechanisms, applicable and relevant deployment scenarios need to be identified. In addition, evaluation methodology for duplex enhancement needs to be developed.

In some mechanisms, SBFD such as simultaneous DL and UL transmission on different physical resource blocks (PRBs) or sub-bands within an unpaired wideband NR cell is proposed. As used herein, the term “SBFD” may also be referred to as cross division duplexing (xDD) or flexible division duplexing (FDU). The SBFD and potential enhancements on dynamic/flexible TDD need to be studied.

In some mechanisms, it is proposed to identify possible schemes and evaluate their feasibility and performances (radio access network 1 (RAN1)). It is further proposed to study inter-gNB and inter-UE CLI handling and identify solutions to manage them (RAN1).

Intra-sub-band CLI and inter-sub-band CLI in case of the SBFD need to be considered. The performance of the identified schemes as well as the impact on legacy operation assuming their co-existence in co-channel and adjacent channels need to be studied.

The feasibility of and impact on RF requirements considering adjacent-channel co-existence with the legacy operation need to be studied (RAN4). The feasibility of and impact on RF requirements considering the self-interference, the inter-sub-band CLI, and the inter-operator CLI at the gNB and the inter-sub-band CLI and inter-operator CLI at UE need to be studied.

In some mechanisms, RAN4 needs to be involved early to provide necessary information to RAN1 as needed and to study the feasibility aspects due to high impact in antenna/RF and algorithm design, which include antenna isolation, TX IM suppression in the RX part, filtering and digital interference suppression. Therefore, potential enhancements on dynamic/flexible TDD need to be considered.

In some mechanisms, an antenna configuration with transition period may be use for reciprocal channel estimation for TDD. However, the transition period (also referred to as a gap) may occur in UL transmissions across SBFD and UL slot for switching between the connection of transmission (Rx) Chain connected to panel group #1 antenna elements and Rx Chain connected to panel group #2 antenna elements.

In some mechanism, another antenna configuration which may not require any gap in UL transmissions across SBFD and UL slot may be applied. However, such antenna configuration cannot provide good reciprocal channel estimation. Therefore, how to support both good channel reciprocity and avoid the transition period is one issue to be solved.

In order to solve at least part of the above problems or other potential problems, a solution on SBFD pattern with antenna switching is proposed. According to example embodiments, a first apparatus (for example, a terminal device) determines information related to antenna switching by a second apparatus (for example, a network device) within a subset of SBFD patterns of a set of SBFD patterns. For example, the antenna switching may be performed by the second apparatus within the subset of SBFD patterns. No antenna switching may be within a remaining subset of SBFD patterns. The first apparatus thus determines at least one time point for antenna switching at least based on the information related to the antenna switching. In some example embodiments, the first apparatus may cease at least one of a transmission or a reception during the antenna switching by the second apparatus.

In this manner, the first apparatus can be aware of the at least one time point for antenna switching. In this way, the first apparatus can cease the transmission and/or reception during the antenna switching based on the determined at least one time point for antenna switching.

Principle and implementations of the present disclosure will be described in detail below with reference to FIGS. 1-11.

FIG. 1 illustrates an example communication environment 100 in which example embodiments of the present disclosure can be implemented. In the communication environment 100, a plurality of communication apparatuses, including a first apparatus 110 and a second apparatus 120, can communicate with each other.

The communication environment 100 may support various of duplexing modes, such as FDD and TDD. In some example embodiments, SBFD may be supported by the first apparatus 110 and the second apparatus 120.

In some example embodiments, if the first apparatus 110 is a terminal device and the second apparatus 120 is a network device serving the terminal device, a link from the second apparatus 120 to the first apparatus 110 is referred to as a downlink (DL), while a link from the first apparatus 110 to the second apparatus 120 is referred to as an uplink (UL). In DL, the second apparatus 120 is a transmitting (TX) device (or a transmitter) and the first apparatus 110 is a receiving (RX) device (or a receiver). In UL, the first apparatus 110 is a TX device (or a transmitter) and the second apparatus 120 is a RX device (or a receiver).

It is to be understood that the number of apparatuses and their connections shown in FIG. 1 are only for purpose of illustration without suggesting any limitation. The communication environment 100 may include any suitable number of apparatuses configured to implementing example embodiments of the present disclosure.

In the following, for purpose of illustration, some example embodiments are described with the first apparatus 110 operating as a terminal device and the second apparatus 120 operating as a network device. However, in some example embodiments, operations described in connection with a terminal device may be implemented at a network device or other device, and operations described in connection with a network device may be implemented at a terminal device or other device.

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

As discussed, various of duplexing modes, such as TDD is supported. FIG. 2 illustrates an example diagram 200 showing TDD with shared antenna array. As illustrated, K (K being an integer greater than or equal to 1) Tx chains are connected to a shared Tx/Rx antenna array with L (L being an integer greater than or equal to 1) antenna elements for DL slots or DL symbols during a time duration for DL. K Rx chains are connected to the shared Tx/Rx antenna array with L antenna elements for UL slots or UL symbols during a time duration for UL. For SBFD, the connection between the Tx/Rx chains and the antenna elements may be varied, which will be described with respect to FIG. 4A to FIG. 4E.

FIG. 3 illustrates a signaling diagram 300 for SBFD with antenna switching according to some example embodiments of the present disclosure. The signaling diagram 300 involves the first apparatus 110 and the second apparatus 120 in FIG. 1. For purpose of illustration, the signaling diagram 300 will be described with respect to FIG. 1.

For purpose of discussion, some example embodiments are described where the first apparatus 110 is implemented as a terminal device and the second apparatus 120 is implemented as a network device. In the following description, it is assumed that in the signaling diagram 300, an SBFD mode is enabled or initiated. It is also assumed that duplex enhancement may be at the second apparatus 120, and half duplex operation may be at the first apparatus 110. There may be no restriction on frequency ranges.

In operation, the first apparatus 110 determines (340) information related to antenna switching by the second apparatus 120 within a subset of SBFD patterns of a set of SBFD patterns. For example, the antenna switching may be within each of the subset of SBFD patterns. In other words, each of the subset of SBFD patterns may include a period for the antenna switching. As used herein, the term “a period for the antenna switching” or the term “an antenna switching period” may be referred to a period for switching the antenna(s) by the second apparatus 120. In the following description, unless explicitly stated, it is assumed that the antenna switching is performed by the second apparatus 120. No antenna switching may correspond to a remaining subset of SBFD patterns of the set of SBFD patterns. That is, there is no antenna switching or no antenna switching period within each of the remaining subset of SBFD patterns. The second apparatus 120 may not switch the antenna(s) during the remaining subset of SBFD patterns.

As used herein, the subset of SBFD patterns with antenna switching may be referred to as “a subset of antenna switching SBFD patterns”, “a subset of SBFD patterns with transition period” or “the subset of SBFD patterns” or “a first subset of SBFD patterns”. The remaining subset of SBFD patterns without antenna switching may be referred to as “the remaining subset of SBFD patterns” or “a second subset of SBFD patterns”. The set of SBFD patterns include the first subset and the second subset of SBFD patterns.

It is to be understood that the subset of SBFD patterns may include any suitable number of SBFD patterns, for example, 1, 2 or more than 2. Likewise, the remaining subset of SBFD patterns may include any suitable number of SBFD patterns. Scope of the present disclosure is not limited in this regard.

The first apparatus 110 determines (345) at least one time point for antenna switching by the second apparatus 120 at least based on the information related to the antenna switching. For example, a time point for the antenna switching may be between an SBFD symbol and a non-SBFD symbol in a single SBFD pattern in the subset of SBFD patterns. The antenna switching is performed by the second apparatus 120.

In an example, for a certain SBFD pattern in the subset of SBFD patterns, the certain SBFD pattern may include a first time point for the antenna switching. The first time point is after an SBFD symbol and before a non-SBFD symbol in the certain SBFD pattern. In another example, the certain SBFD pattern may include a second time point for the antenna switching. The second time point is after a non-SBFD symbol and before an SBFD symbol in the certain SBFD pattern. In a further example, the certain SBFD pattern may include both the first time point and the second time point for antenna switching.

In some example embodiments, the first apparatus 110 may cease (350) or drop at least one of a transmission or a reception during the antenna switching by the second apparatus 120. For example, the first apparatus 110 may cease (350) or drop at least one of the transmission or reception during a time period of the antenna switching. With the determined (345) at least one time point, the first apparatus 110 may be aware of where or when to cease (345) the transmission and/or reception.

In some example embodiments, the first apparatus 110 may determine (340) the information related to antenna switching based on a predefined antenna switching pattern. Alternatively, or in addition, in some example embodiments, the antenna switching pattern may be configured or triggered by the second apparatus 120.

In some example embodiments, the second apparatus 120 determines (320) a configuration of the antenna switching pattern. The antenna switching pattern corresponds to the set of SBFD patterns. The configuration indicates the antenna switching within the subset of SBFD patterns of the set of SBFD patterns.

In one example, the second apparatus 120 may determine (320) the configuration of the antenna switching pattern based on a moving speed of the first apparatus 110. For example, the second apparatus 120 may determine (320) and update the configuration of the antenna switching pattern based on changing of the moving speed of the first apparatus 110. It is to be understood that the second apparatus 120 may alternatively determine (320) the configuration of the antenna switching pattern based on other parameters or other rules. Scope of the present disclosure is not limited in this regard.

In some example embodiments, the second apparatus 120 determines (325) at least one time point for antenna switching based on the configuration of the antenna switching pattern. In this way, the second apparatus 120 may determine the antenna switching time and thus do antenna switching at the determined (325) time point.

In example embodiments where the second apparatus 120 determines (320) the configuration of the antenna switching pattern, the second apparatus 120 may transmit (330) the configuration of the antenna switching pattern to the first apparatus 110. The first apparatus 110 may receive (335) the configuration of the antenna switching pattern. The first apparatus 110 may determine (340) the information related to the antenna switching based on the received (335) configuration of the antenna switching pattern.

In some example embodiments, an antenna and chain configuration may be configured for an SBFD pattern. For example, the antenna and chain configuration may be predefined or configured by the second apparatus 120. The antenna and chain configuration may indicate connections between antenna elements and Tx/Rx chains. The information related to antenna switching or the configuration of the antenna switching pattern may be associated with the antenna and chain configuration.

FIG. 4A-FIG. 4E illustrate example antenna and chain configuration for SBFD pattern according to some example embodiments of the present disclosure, respectively. As used herein, unless explicitly stated, the antenna element(s), antenna array(s), or panel group(s) are implemented at the second apparatus 120, or implemented as a part of the second apparatus 120. Likewise, unless explicitly stated, the Tx chain(s), Rx chain(s), Tx/Rx chain(s), Tx radio unit(s) (TxRU(s)), or RxRU(s) or transceiver unit(s) are implemented at the second apparatus 120 or implemented as a part of the second apparatus 120. In other words, in description with respect to FIG. 4A to FIG. 4E, all of the Tx chain, Rx chain, Tx/Rx chain, TxRU, RxRU, antenna elements, antenna array, panel group are of the second apparatus 120.

In one example, a first antenna and Tx/Rx chain configuration (also referred to as configuration option 1 or method 1) may be configured. The connection between antenna elements and Tx/Rx chains based on the first antenna and Tx/Rx chain configuration is shown in FIG. 4A. Specifically, in DL slots or symbols, L/2 antenna elements on panel group #1 are connected to K/2 Tx chains in transceiver unit (TxRU) group #1, and L/2 antenna elements on panel group #2 are connected to K/2 Tx chains in TxRU group #2. In UL slots or symbols, L/2 antenna elements on panel group #1 are connected to K/2 Rx chains in TxRU group #1, and L/2 antenna elements on panel group #2 are connected to K/2 Rx chains in TxRU group #2. In SBFD slots or symbols, L/2 antenna elements on panel group #1 are connected to K/2 Tx chains in TxRU group #1, and L/2 antenna elements on panel group #2 are connected to K/2 Rx chains in TxRU group #2.

In another example, a second antenna and Tx/Rx chain configuration (also referred to as configuration option 2 or method 2) may be configured. For the configuration option-2, the separate-Tx/Rx antenna array has two panel groups. The total number of TXRUs (referred to as K) is the same as legacy TDD, and the total number of antenna elements (referred to as 2L) is two times of that for legacy TDD. There are two sub-options or two sub-methods for the configuration option 2 on the usage of TXRUs and antenna elements in DL/UL/SBFD slots/symbols. Two kinds of connections between antenna elements and Tx/Rx chains based on the second antenna and Tx/Rx chain configuration are shown in FIG. 4B and FIG. 4C, respectively.

FIG. 4B illustrates the connection between antenna elements and Tx/Rx chains based on the configuration option 2-1 (also referred to as method 2-1). As illustrated, in DL slots or symbols, L antenna elements on panel group #1 are connected to K Tx chains. In UL slots or symbols, L antenna elements on panel group #2 are connected to K Rx chains. In SBFD slots or symbols, L antenna elements on panel group #1 are connected to K Tx chains, and L antenna elements on panel group #2 are connected to K Rx chains. Here, the same L antenna elements on panel group #2 are connected to K Rx chains in UL slots or symbols and SBFD slots or symbols.

FIG. 4C illustrates the connection between antenna elements and Tx/Rx chains based on the configuration option 2-2 (also referred to as method 2-2). As illustrated, in DL slots or symbols, L antenna elements on panel group #1 are connected to K Tx chains. In UL slots or symbols, L antenna elements on panel group #1 are connected to K Rx chains. In SBFD slots or symbols, L antenna elements on panel group #1 are connected to K Tx chains, and L antenna elements on panel group #2 are connected to K Rx chains. Here, different L antenna elements on panel group are connected to K Rx chains in UL slots or symbols and SBFD slots or symbols.

In a further example, a third antenna and Tx/Rx chain configuration (also referred to as configuration option 3 or method 3) may be configured. For the configuration option-3, the separate-Tx/Rx antenna array has two panel groups. The total number of TXRUs is K/2 (half of that for legacy TDD), and the total number of antenna elements is L (same as legacy TDD). There are two sub-options or two sub-methods for the configuration option 3 on the usage of TXRUs and antenna elements in DL/UL/SBFD slots/symbols. Two kinds of connections between antenna elements and Tx/Rx chains based on the third antenna and Tx/Rx chain configuration are shown in FIG. 4D and FIG. 4E, respectively.

FIG. 4D illustrates the connection between antenna elements and Tx/Rx chains based on the configuration option 3-1 (also referred to as method 3-1). As illustrated, in DL slots or symbols, L/2 antenna elements on panel group #1 are connected to K/2 Tx chains. In UL slots or symbols, L/2 antenna elements on panel group #2 are connected to K/2 Rx chains. In SBFD slots or symbols, L/2 antenna elements on panel group #1 are connected to K/2 Tx chains, and L/2 antenna elements on panel group #2 are connected to K/2 Rx chains. Here, the same L/2 antenna elements on panel group #2 are connected to K/2 Rx chains in UL slots or symbols and SBFD slots or symbols.

] FIG. 4E illustrates the connection between antenna elements and Tx/Rx chains based on the configuration option 3-1 (also referred to as method 3-1). As illustrated, in DL slots or symbols, L/2 antenna elements on panel group #1 are connected to K/2 Tx chains in TxRU group #1. In UL slots or symbols, L/2 antenna elements on panel group #1 are connected to K/2 Rx chains in TxRU group #1. In SBFD slots or symbols, L/2 antenna elements on panel group #1 are connected to K/2 Tx chains in TxRU group #1, and L/2 antenna elements on panel group #2 are connected to K/2 Rx chains in TxRU group #1. Here, different L/2 antenna elements on panel group are connected to K/2 Rx chains in UL slots or symbols and SBFD slots or symbols.

As illustrated with respect to FIG. 4C and FIG. 4E, for the antenna and Tx/Rx chain configuration 2-2 and 3-2 illustrated above, an antenna switching will occur. FIG. 5A illustrates an example SBFD pattern 500 according to some example embodiments of the present disclosure. The SBFD pattern 500 may include a non-SBFD slot 510 for DL, an SBFD slot 520-1, an SBFD slot 520-2, an SBFD slot 520-3, and a non-SBFD slot 530 for UL. As used herein, the SBFD slot 520-1, 520-2 and 520-3 may be collectively referred to as “SBFD slots 520”. The SBFD pattern 500 may correspond to the antenna and Tx/Rx chain configuration 2-2 or 3-2. That is, a transition period 540 between the SBFD slot 520-3 and the non-SBFD slot 530 may exist. The antenna switching period for the antenna switching performed by the second apparatus 120 may include the transition period 540. For example, the antenna switching may happen during the transition period 540. As used herein, the term “transition period” may refer to a time period or a gap for the antenna switching.

By contrast, as illustrated with respect to FIG. 4B and FIG. 4D, for the antenna and Tx/Rx chain configuration 2-1 and 3-1 illustrated above, there is no antenna switching. FIG. 5B illustrates an example SBFD pattern 550 without antenna switching according to some example embodiments of the present disclosure. The SBFD pattern 550 may include a non-SBFD slot 510 for DL, an SBFD slot 560-1, an SBFD slot 560-2, an SBFD slot 560-3, and a non-SBFD slot 530 for UL. As used herein, the SBFD slot 560-1, 560-2 and 560-3 may be collectively referred to as “SBFD slots 560”. The SBFD pattern 550 may correspond to the antenna and Tx/Rx chain configuration 2-1 or 3-1. That is, no transition period is within the SBFD pattern 550.

It is to be understood that the example SBFD pattern 500 and SBFD pattern 550 are only for purpose of illustration, without suggesting any limitations. For example, for the SBFD pattern corresponding to the antenna and Tx/Rx chain configuration 2-2 or 3-2, there may be two transition periods for antenna switching. Any suitable SBFD pattern with antenna switching may be configured for the antenna and Tx/Rx chain configuration 2-2 or 3-2. Likewise, any suitable SBFD pattern without antenna switching may be configured for the antenna and Tx/Rx chain configuration 2-1 or 3-1. Scope of the present disclosure is not limited in this regard.

Refers back to FIG. 3. As discussed, the first apparatus 110 determines (340) information related to antenna switching by the second apparatus 120, and determines (345) the at least one time point for antenna switching. In this manner, the first apparatus 110 may determine whether the antenna switching is within a certain SBFD pattern. Thus, the first apparatus 110 can determine where to cease the transmission and/or reception.

In some example embodiments, the first apparatus 110 may determine (340) the information related to the antenna switching based on a predefined configuration of the antenna switching pattern, or based on the configuration of the antenna switching pattern received (335) from the second apparatus 120. The configuration of the antenna switching pattern may indicate whether the antenna switching may occur in a certain SBFD pattern.

In one example, the configuration of the antenna switching pattern may include a pattern of antenna switching among the set of SBFD patterns. For example, the pattern may include one or more antenna switching period in the antenna switching pattern. For example, the antenna switching pattern may correspond to a period of 100 SBFD patterns, and there may be 1, 2 or 5 antenna switching among the 100 SBFD patterns. That is, a subset of 1, 2 or 5 SBFD patterns in the 100 SBFD patterns may with antenna switching. It is to be understood that the example number of SBFD patterns and the number of antenna switching are only for purpose of illustration, without suggesting any limitation.

In another example, the configuration of the antenna switching pattern may include a period of the antenna switching pattern. The period of the antenna switching pattern may correspond to a number of periods of the SBFD patterns. As one example, the period or time duration (also referred to as a size) of antenna switching pattern is multiple times of the time duration or length of the SBFD pattern.

In some example embodiments, the period for antenna switching pattern (also referred to as antenna switching period) is different from the SBFD pattern/period and is with size as multiple of SBFD pattern size. One or two positions of the transition period in a single SBFD pattern in the antenna switching pattern may be provided. If a single transition period is provided, it may be for switching from SBFD to non-SBFD UL, as shown in FIG. 5A. Otherwise, the single transition period may be for switching from non-SBFD to SBFD symbol. If two transition periods are provided, one transition period may be used for switching from non-SBFD to SBFD symbol, while another transition period may be from SBFD to non-SBFD symbol.

In the scheduling of UL or DL, both the first apparatus 110 and the second apparatus 120 may assume there is one or two transmission periods. While in other SBFD pattern such as the remaining subset of SBFD patterns, there will be no transition point and the first apparatus 110 may use all SBFD or non-SBFD symbol for data transmission/reception.

The at least one position of the SBFD pattern with transmission period may be at least one of the SBFD patterns in the antenna switching pattern (that is, the subset of SBFD patterns). The position of the subset of SBFD patterns in the antenna switching pattern may be configured based on the configuration of antenna switching patterns.

In a further example, the configuration of the antenna switching pattern may include at least one offset of at least one SBFD pattern with antenna switching among the set of SBFD patterns. For example, the configuration of the antenna switching pattern may indicate the offsets with the subset of SBFD patterns.

In a still further example, the configuration of the antenna switching pattern may include an indication of the subset of SBFD patterns for antenna switching. For example, the indication may indicate a single SBFD pattern in the subset of SBFD patterns or indicate the subset of SBFD patterns. The indicated SBFD pattern may also be referred to as a triggered SBFD pattern.

For example, for a subset (e.g., 49/50 or even 99/100, 999/1000) of the set of SBFD patterns (period or configured/triggered), method 2-1/3-1, i.e., Rx chain connect to the same group of antenna elements, may be used without transition period between SBFD and non-SBFD symbols.

While for a subset (e.g., 1/50 or even 1/100, 1/1000) of the set of SBFD patterns (period or configured/triggered), method 2-2/3-2, i.e., there is switch between Rx chain connect to one group of antenna elements that is used for DL and Rx chain connect to another group of antenna elements, may be used with transition period between SBFD and non-SBFD symbols.

A period processing may be performed, e.g. in each period of 100 ms, there is a single slot with method 2-2/3-2 (i.e. there is switch between Rx chain connect to one group of antenna elements that is used for DL and Rx chain connect to another group of antenna elements) used with transmission period, while with other slots, method 2-1/3-1, i.e. Rx chain connect to the same group of antenna elements, may be used without transition period.

It is to be understood that the example numbers or values mentioned herein are only for the purpose of illustration, without suggesting any limitation. It is to be understood that these example configurations of the antenna switching pattern may be used in any suitable combination, or used separately. For example, in one example, the configuration of the antenna switching pattern indicate an indication of a single SBFD pattern with antenna switching and an offset. The subset of the SBFD pattern with antenna switching may be determined based on the indication and the offset.

FIG. 6 illustrates an example antenna switching pattern 630 according to some example embodiments of the present disclosure. The antenna switching pattern 630 may be configured based on the configuration of the antenna switching pattern. As illustrated, an SBFD pattern 610 in the antenna switching pattern 630 is with antenna switching. That is, the antenna switching may be within the SBFD pattern 610. In other words, an antenna switching period or a transition period is within the SBFD pattern 610. The SBFD pattern 620 in the antenna switching pattern 630 is without the antenna switching. That is, no antenna switching period or no transition period is within the SBFD pattern 620.

In some example embodiments, there may be an additional antenna switching period (not shown) between the SBFD pattern 610 and the SBFD pattern 620. During the additional antenna switching period, the second apparatus 120 may switch the antenna back. The additional antenna switching period may be in the SBFD pattern 610. For example, a part of a last UL slot or an ending UL slot in the SBFD pattern 610 may be used for the antenna switching. The second apparatus 120 may perform the antenna switching during the part of the last UL slot. In such cases, the first apparatus 110 may determine to cease at least one of a transmission or a reception during the part of the last UL slot for antenna switching by the second apparatus 120.

It is to be understood that the additional antenna switching period for switching back the antenna may be optional. Whether there is an additional antenna switching period may be predefine or configured by the second apparatus 120. For example, the additional antenna switching may be predefined or configured by the antenna switching pattern. The first apparatus 110 may determine the time point for the additional antenna switching period based on the predefined or configured antenna switching pattern.

Referring back to FIG. 3, in some example embodiments, the second apparatus 120 may transmit (310) a configuration of the SBFD pattern to the first apparatus 110. The first apparatus 110 may receive (315) the configuration of the SBFD pattern. The SBFD pattern may include a time duration of the SBFD pattern, a time period for SBFD symbols within the SBFD pattern, and/or a time period for non-SBFD symbols within the SBFD pattern. For example, the SBFD pattern 610 and the SBFD pattern 620 in FIG. 6 may be configured by the configuration of the SBFD pattern.

In some example embodiments, based on the configuration of SBFD pattern and the configuration of antenna switching pattern, Rx chain of the second apparatus 120 may only connect to a group of antenna elements at a time. If needed, the Rx chain may connect to another group of antenna elements within a transition period, while at least Rx will be stopped during the transition period or both Tx and Rx will be stopped during the transition period.

In some example embodiments, the first apparatus 110 may determine (345) the at least one time point for the antenna switching based on the information related to the antenna switching and a configuration of the SBFD pattern. For example, the first apparatus 110 may determine that point for antenna switching within a determined SBFD pattern with antenna switching based on the configuration of the SBFD pattern. The first apparatus 110 may cease (350) a transmission and/or reception during the antenna switching by the second apparatus. In other words, the first apparatus 110 may stop UL and/or DL in the antenna switching period or the transition period of SBFD period in the antenna switching pattern.

Likewise, the second apparatus 120 may determine (325) the at least one point for the antenna switching based on the configuration of the antenna switching pattern and the configuration of the SBFD pattern. The second apparatus 120 may cease (355) a transmission and/or reception during the antenna switching.

In some example embodiments, the first apparatus 110 may determine (360) that no antenna switching is within a remaining subset of the set of SBFD patterns, for example based on the information related to antenna switching. The first apparatus 110 may continue UL and DL in SBFD period without antenna switching or without transmission period. Likewise, the second apparatus 120 may determine (365) that no antenna switching is within the remaining subset of the set of SBFD patterns, for example based on the configuration of the antenna switching pattern. The second apparatus 120 may continue UL and DL in SBFD period without antenna switching or without transmission period.

In some example embodiments, the second apparatus 120 may determine (370) a relationship between channel states associated with a first group of antenna elements for transmission and a second group of antenna elements for reception during a first SBFD pattern with antenna switching. For example, the second apparatus 120 may determine a first channel state such as a first channel status matrix H_{P1} associated with a group of antenna elements for transmission for example, a non-SBFD DL slot/symbol. The second apparatus 120 may determine a second channel state such as a second channel status matrix H_{P2} associated with a group of antenna elements for reception for example, a non-SBFD UL slot/symbol. The second apparatus 120 thus may determine (370) the relationship between channel states as a relationship matric H_{P1,P2}=H_{P1}/H_{P2}. That is, when 2-2/3-2 is used, network may calculate a channel status matrix H_{P1,P2}=H_{P1}/H_{P2}.

The second apparatus 120 may perform, based on the relationship between the channel states, during a second SBFD pattern after the first SBFD pattern, at least one of: a transmission via the second group of antenna elements, or a reception via the first group of antenna elements. For example, while when method 2-1/3-1 is used, the channel estimation will be H_{P2} and calculated as H_{P1}=H_{P2}*H_{P1,P2} so that reciprocal channel estimation may be used.

In some example embodiments, for more accurate channel reciprocity information, but with more transition period, for example, multi-user (MU) multiple input multiple output (MIMO) UE paring cases may be applied.

In some example embodiments, the first apparatus 110 may receive, from the second apparatus 120, a configuration of a reference signal such as a sounding reference signal (SRS). The first apparatus 110 may transmit, to the second apparatus 120, the reference signal in the subset of SBFD patterns based on the configuration of the reference signal. In an example, the first apparatus 110 may transmit certain signals according to the configuration by the second apparatus 120 only in the subset of the SBFD patterns for which antenna switching is determined. For example, SRS transmissions used by the second apparatus 120 for DL beamforming may only be needed when DL panel is used for UL reception (i.e., when antenna switching is applied).

In this way, the first apparatus 110 may be restricted to transmit using one or more SRS configurations during slots that assume method 2-2/3-2. For example, in the SBFD pattern to use method 2-2 or 3-2, the SRS may be transmitted for the calculation of H_{P1,P2}=H_{P1}/H_{P2}. While the SRS transmitted in SBFD pattern using method 2-1 or 3-1, the SRS may be transmitted for calculation of H_{P2}.

By using the signaling diagram 300 for SBFD with Rx chain, the Rx chain may connect to a group of antenna elements at a time, to have reciprocity channel estimation but reduce number of transition period. This will provide resource saving and higher throughput for SBFD system. Such solution can be applied to the configuration option or method 2, 3 or any other suitable configuration or method for case there is switch between Rx chain connect to one group of antenna elements that is used for DL and Rx chain connect to another group of antenna elements.

In this manner, it can reduce a number of the transition period because of switching between connections of antenna and Rx chain, thus providing resource saving and throughput improvement with more resource.

FIG. 7 illustrates an example process 700 for determining an antenna switching within an SBFD pattern according to some example embodiments of the present disclosure. For the purpose of discussion, the method 700 will be described from the perspective of the first apparatus 110 in FIG. 1.

At block 710, the first apparatus 110 may receive a configuration of antenna switching pattern and a configuration of SBFD pattern from the second apparatus 120. The configuration of antenna switching pattern and the configuration of SBFD pattern have been described with respect to FIG. 3, which will not be repeated here.

At block 720, the first apparatus 110 may determine whether a certain SBFD pattern is an SBFD pattern with antenna switching. For example, the first apparatus 110 may make the determination for each SBFD pattern in the antenna switching pattern.

If the first apparatus 110 determines that a certain SBFD pattern is the SBFD pattern with antenna switching, at block 730, the first apparatus 110 may drop Rx or drop both Rx and Tx in the antenna switching period or the transition period of the certain SBFD pattern.

Otherwise, if a certain SBFD pattern is not an SBFD pattern with antenna switching, at block 740, the first apparatus 110 may not consider the antenna switching period or the transition period in the certain SBFD pattern. For example, the first apparatus 110 may continue performing transmission or reception in the certain SBFD pattern without antenna switching.

In this manner, it can reduce a number of the transition period because of switching between connections of antenna and Rx chain, thus providing resource saving and throughput improvement with more resource. In this way, the duplex evolution for NR in unpaired spectrum can be potentially enhanced.

Several example embodiments regarding the SBFD pattern with antenna switching have been described. It is to be understood that the signaling diagram 300 and the process 700 are only for purpose of illustration, without suggesting any limitation. The signaling diagram 300 and the process 700 can be used in any suitable combination or used separately. With the signaling diagram 300 and/or the process 700, different SBFD patterns may be supported by the first apparatus 110 and the second apparatus 120. For example, both SBFD pattern with antenna switching and SBFD pattern without antenna switching can be configured in a same antenna switching pattern. In this manner, it can reduce a number of the transition period because of switching between connections of antenna and Rx chain, thus providing resource saving and throughput improvement with more resource. In this way, the duplex evolution for NR in unpaired spectrum can be potentially enhanced.

FIG. 8 shows a flowchart of an example method 800 implemented at a first apparatus in accordance with some example embodiments of the present disclosure. For the purpose of discussion, the method 800 will be described from the perspective of the first apparatus 110 in FIG. 1.

At block 810, the first apparatus 110 determines information related to antenna switching within a subset of sub-band non-overlapping full duplex (SBFD) patterns of a set of SBFD patterns.

At block 820, the first apparatus 110 determines, at least based on the information related to the antenna switching, at least one time point for antenna switching.

In some example embodiments, the method 800 further comprises: ceasing at least one of a transmission or a reception during the antenna switching by the second apparatus.

In some example embodiments, the method 800 further comprises: receiving, from a second apparatus, a configuration of an antenna switching pattern corresponding to the set of SBFD patterns, to indicate the antenna switching within the subset of SBFD patterns; and determining the information related to the antenna switching based on the configuration of the antenna switching pattern.

In some example embodiments, the configuration of the antenna switching pattern includes at least one of: a pattern of antenna switching among the set of SBFD patterns, a period of the antenna switching pattern, at least one offset of at least one SBFD pattern with antenna switching among the set of SBFD patterns, or an indication of the subset of SBFD patterns for antenna switching.

In some example embodiments, the method 800 further comprises: determining the at least one time point for the antenna switching based on the information related to the antenna switching and a configuration of the SBFD pattern.

In some example embodiments, an SBFD pattern in the subset of SBFD patterns includes at least one of: a first time point for the antenna switching, the first time point being after an SBFD symbol and being before a non-SBFD symbol in the SBFD pattern, or a second time point for the antenna switching, the second time point being after a non-SBFD symbol and being before an SBFD symbol in the SBFD pattern.

In some example embodiments, the method 800 further comprises: determining that no antenna switching is within a remaining subset of the set of SBFD patterns.

In some example embodiments, the method 800 further comprises: receiving, from the second apparatus, a configuration of a reference signal; and transmitting, to the second apparatus, the reference signal in the subset of SBFD patterns based on the configuration of the reference signal.

FIG. 9 shows a flowchart of an example method 900 implemented at a second apparatus in accordance with some example embodiments of the present disclosure. For the purpose of discussion, the method 900 will be described from the perspective of the second apparatus 120 in FIG. 1.

At block 910, the second apparatus 120 determines a configuration of an antenna switching pattern corresponding to a set of sub-band non-overlapping full duplex (SBFD) patterns, the configuration indicating antenna switching within a subset of SBFD patterns of the set of SBFD patterns.

At block 920, the second apparatus 120 determines at least one time point for antenna switching based on the configuration of the antenna switching pattern.

In some example embodiments, the method 900 further comprises: transmitting, to a first apparatus, the configuration of the antenna switching pattern.

In some example embodiments, the method 900 further comprises: ceasing at least one of a transmission or a reception during the antenna switching.

In some example embodiments, the configuration of the antenna switching pattern includes at least one of: a pattern of antenna switching among the set of SBFD patterns, a period of the antenna switching pattern, at least one offset of at least one SBFD pattern with antenna switching among the set of SBFD patterns, or an indication of the subset of SBFD patterns for antenna switching.

In some example embodiments, the method 900 further comprises: determining the configuration of the antenna switching pattern based on a moving speed of the first apparatus.

In some example embodiments, an SBFD pattern in the subset of SBFD patterns includes at least one of: a first time point for the antenna switching, the first time point being after an SBFD symbol and being before a non-SBFD symbol in the SBFD pattern, or a second time point for the antenna switching, the second time point being after a non-SBFD symbol and being before an SBFD symbol in the SBFD pattern.

In some example embodiments, the method 900 further comprises: determining that no antenna switching is within a remaining subset of the set of SBFD patterns.

In some example embodiments, the method 900 further comprises: transmitting, to a first apparatus, a configuration of a reference signal; and receiving, from the first apparatus, the reference signal in the subset of SBFD patterns based on the configuration of the reference signal.

In some example embodiments, the method 900 further comprises: determining a relationship between channel states associated with a first group of antenna elements for transmission and a second group of antenna elements for reception during a first SBFD pattern with antenna switching; and performing, based on the relationship between the channel states, during a second SBFD pattern after the first SBFD pattern, at least one of: a transmission via the second group of antenna elements, or a reception via the first group of antenna elements.

In some example embodiments, a first apparatus capable of performing any of the method 800 (for example, the first apparatus 110 in FIG. 1) may comprise means for performing the respective operations of the method 800. The means may be implemented in any suitable form. For example, the means may be implemented in a circuitry or software module. The first apparatus may be implemented as or included in the first apparatus 110 in FIG. 1.

In some example embodiments, the first apparatus comprises means for determining information related to antenna switching within a subset of sub-band non-overlapping full duplex (SBFD) patterns of a set of SBFD patterns; and means for determining, at least based on the information related to the antenna switching, at least one time point for antenna switching.

In some example embodiments, the first apparatus further comprises: means for ceasing at least one of a transmission or a reception during the antenna switching by the second apparatus.

In some example embodiments, the first apparatus further comprises: means for receiving, from a second apparatus, a configuration of an antenna switching pattern corresponding to the set of SBFD patterns, to indicate the antenna switching within the subset of SBFD patterns; and means for determining the information related to the antenna switching based on the configuration of the antenna switching pattern.

In some example embodiments, the configuration of the antenna switching pattern includes at least one of: a pattern of antenna switching among the set of SBFD patterns, a period of the antenna switching pattern, at least one offset of at least one SBFD pattern with antenna switching among the set of SBFD patterns, or an indication of the subset of SBFD patterns for antenna switching.

In some example embodiments, the first apparatus further comprises: means for determining the at least one time point for the antenna switching based on the information related to the antenna switching and a configuration of the SBFD pattern.

In some example embodiments, an SBFD pattern in the subset of SBFD patterns includes at least one of: a first time point for the antenna switching, the first time point being after an SBFD symbol and being before a non-SBFD symbol in the SBFD pattern, or a second time point for the antenna switching, the second time point being after a non-SBFD symbol and being before an SBFD symbol in the SBFD pattern.

In some example embodiments, the first apparatus further comprises: means for determining that no antenna switching is within a remaining subset of the set of SBFD patterns.

In some example embodiments, the first apparatus further comprises: means for receiving, from the second apparatus, a configuration of a reference signal; and means for transmitting, to the second apparatus, the reference signal in the subset of SBFD patterns based on the configuration of the reference signal.

In some example embodiments, the first apparatus further comprises means for performing other operations in some example embodiments of the method 800 or the first apparatus 110. In some example embodiments, the means comprises at least one processor; and at least one memory storing instructions that, when executed by the at least one processor, cause the performance of the first apparatus.

In some example embodiments, a second apparatus capable of performing any of the method 900 (for example, the second apparatus 120 in FIG. 1) may comprise means for performing the respective operations of the method 900. The means may be implemented in any suitable form. For example, the means may be implemented in a circuitry or software module. The second apparatus may be implemented as or included in the second apparatus 120 in FIG. 1.

In some example embodiments, the second apparatus comprises means for determining a configuration of an antenna switching pattern corresponding to a set of sub-band non-overlapping full duplex (SBFD) patterns, the configuration indicating antenna switching within a subset of SBFD patterns of the set of SBFD patterns, and means for determining at least one time point for antenna switching based on the configuration of the antenna switching.

In some example embodiments, the second apparatus further comprises: means for transmitting, to a first apparatus, the configuration of the antenna switching pattern.

In some example embodiments, the second apparatus further comprises: means for ceasing at least one of a transmission or a reception during the antenna switching.

In some example embodiments, the configuration of the antenna switching pattern includes at least one of: a pattern of antenna switching among the set of SBFD patterns, a period of the antenna switching pattern, at least one offset of at least one SBFD pattern with antenna switching among the set of SBFD patterns, or an indication of the subset of SBFD patterns for antenna switching.

In some example embodiments, the second apparatus further comprises: means for determining the configuration of the antenna switching pattern based on a moving speed of the first apparatus.

In some example embodiments, an SBFD pattern in the subset of SBFD patterns includes at least one of: a first time point for the antenna switching, the first time point being after an SBFD symbol and being before a non-SBFD symbol in the SBFD pattern, or a second time point for the antenna switching, the second time point being after a non-SBFD symbol and being before an SBFD symbol in the SBFD pattern.

In some example embodiments, the second apparatus further comprises: means for determining that no antenna switching is within a remaining subset of the set of SBFD patterns.

In some example embodiments, the second apparatus further comprises: means for transmitting, to a first apparatus, a configuration of a reference signal; and means for receiving, from the first apparatus, the reference signal in the subset of SBFD patterns based on the configuration of the reference signal.

In some example embodiments, the second apparatus further comprises: means for determining a relationship between channel states associated with a first group of antenna elements for transmission and a second group of antenna elements for reception during a first SBFD pattern with antenna switching; and means for performing, based on the relationship between the channel states, during a second SBFD pattern after the first SBFD pattern, at least one of: a transmission via the second group of antenna elements, or a reception via the first group of antenna elements.

In some example embodiments, the second apparatus further comprises means for performing other operations in some example embodiments of the method 900 or the second apparatus 120. In some example embodiments, the means comprises at least one processor; and at least one memory storing instructions that, when executed by the at least one processor, cause the performance of the second apparatus.

FIG. 10 is a simplified block diagram of a device 1000 that is suitable for implementing example embodiments of the present disclosure. The device 1000 may be provided to implement a communication device, for example, the first apparatus 110 or the second apparatus 120 as shown in FIG. 1. As shown, the device 1000 includes one or more processors 1010, one or more memories 1020 coupled to the processor 1010, and one or more communication modules 1040 coupled to the processor 1010.

The communication module 1040 is for bidirectional communications. The communication module 1040 has one or more communication interfaces to facilitate communication with one or more other modules or devices. The communication interfaces may represent any interface that is necessary for communication with other network elements. In some example embodiments, the communication module 1040 may include at least one antenna.

The processor 1010 may be of any type suitable to the local technical network and may include one or more of the following: general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

The memory 1020 may include one or more non-volatile memories and one or more volatile memories. Examples of the non-volatile memories include, but are not limited to, a Read Only Memory (ROM) 1024, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 1022 and other volatile memories that will not last in the power-down duration.

A computer program 1030 includes computer executable instructions that are executed by the associated processor 1010. The instructions of the program 1030 may include instructions for performing operations/acts of some example embodiments of the present disclosure. The program 1030 may be stored in the memory, e.g., the ROM 1024. The processor 1010 may perform any suitable actions and processing by loading the program 1030 into the RAM 1022.

The example embodiments of the present disclosure may be implemented by means of the program 1030 so that the device 1000 may perform any process of the disclosure as discussed with reference to FIG. 3 to FIG. 9. The example embodiments of the present disclosure may also be implemented by hardware or by a combination of software and hardware.

In some example embodiments, the program 1030 may be tangibly contained in a computer readable medium which may be included in the device 1000 (such as in the memory 1020) or other storage devices that are accessible by the device 1000. The device 1000 may load the program 1030 from the computer readable medium to the RAM 1022 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 11 shows an example of the computer readable medium 1100 which may be in form of CD, DVD or other optical storage disk. The computer readable medium 1100 has the program 1030 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A first apparatus comprising:
at least one processor; and
at least one memory storing instructions that, when executed by the at least one processor, cause the first apparatus to:
determine information related to antenna switching by a second apparatus within a subset of sub-band non-overlapping full duplex (SBFD) patterns of a set of SBFD patterns; and
determine, at least based on the information related to the antenna switching, at least one time point for antenna switching.

2. The first apparatus of claim 1, wherein the first apparatus is caused to:
cease at least one of a transmission or a reception during the antenna switching by the second apparatus.

3. The first apparatus of claim 1, wherein the first apparatus is caused to:
receive, from the second apparatus, a configuration of an antenna switching pattern corresponding to the set of SBFD patterns, to indicate the antenna switching within the subset of SBFD patterns; and
determine the information related to the antenna switching based on the configuration of the antenna switching pattern.

4. The first apparatus of claim 3, wherein the configuration of the antenna switching pattern includes at least one of:
a pattern of antenna switching among the set of SBFD patterns,
a period of the antenna switching pattern,
at least one offset of at least one SBFD pattern with antenna switching among the set of SBFD patterns, or
an indication of the subset of SBFD patterns for antenna switching.

5. The first apparatus of claim 1, wherein the first apparatus is caused to:
determine the at least one time point for the antenna switching based on the information related to the antenna switching and a configuration of the SBFD pattern.

6. The first apparatus of claim 1, wherein an SBFD pattern in the subset of SBFD patterns includes at least one of:
a first time point for the antenna switching, the first time point being after an SBFD symbol and being before a non-SBFD symbol in the SBFD pattern, or
a second time point for the antenna switching, the second time point being after a non-SBFD symbol and being before an SBFD symbol in the SBFD pattern.

7. The first apparatus of claim 1, wherein the first apparatus is caused to:
determine that no antenna switching is within a remaining subset of the set of SBFD patterns.

8. The first apparatus of claim 1, wherein the first apparatus is caused to:
receive, from the second apparatus, a configuration of a reference signal; and
transmit, to the second apparatus, the reference signal in the subset of SBFD patterns based on the configuration of the reference signal.

9. A second apparatus comprising:
at least one processor; and
at least one memory storing instructions that, when executed by the at least one processor, cause the second apparatus to:
determine a configuration of an antenna switching pattern corresponding to a set of sub-band non-overlapping full duplex (SBFD) patterns, the configuration indicating antenna switching by the second apparatus within a subset of SBFD patterns of the set of SBFD patterns; and
determine at least one time point for antenna switching based on the configuration of the antenna switching pattern.

10. The second apparatus of claim 9, wherein the second apparatus is caused to:
transmit, to a first apparatus, the configuration of the antenna switching pattern.

11. The second apparatus of claim 9, wherein the second apparatus is caused to:
cease at least one of a transmission or a reception during the antenna switching.

12. The second apparatus of claim 9, wherein the configuration of the antenna switching pattern includes at least one of:
a pattern of antenna switching among the set of SBFD patterns,
a period of the antenna switching pattern,
at least one offset of at least one SBFD pattern with antenna switching among the set of SBFD patterns, or
an indication of the subset of SBFD patterns for antenna switching.

13. The second apparatus of claim 9, wherein the second apparatus is further caused to:
determine the configuration of the antenna switching pattern based on a moving speed of the first apparatus.

14. The second apparatus of claim 9, wherein an SBFD pattern in the subset of SBFD patterns includes at least one of:
a first time point for the antenna switching, the first time point being after an SBFD symbol and being before a non-SBFD symbol in the SBFD pattern, or
a second time point for the antenna switching, the second time point being after a non-SBFD symbol and being before an SBFD symbol in the SBFD pattern.

15. The second apparatus of claim 9, wherein the second apparatus is caused to:
determine that no antenna switching is within a remaining subset of the set of SBFD patterns.

16. The second apparatus of claim 9, wherein the second apparatus is caused to:
transmit, to a first second apparatus, a configuration of a reference signal; and
receive, from the first apparatus, the reference signal in the subset of SBFD patterns based on the configuration of the reference signal.

17. The second apparatus of claim 9, wherein the second apparatus is caused to:
determine a relationship between channel states associated with a first group of antenna elements for transmission and a second group of antenna elements for reception during a first SBFD pattern with antenna switching; and
perform, based on the relationship between the channel states, during a second SBFD pattern after the first SBFD pattern, at least one of:
a transmission via the second group of antenna elements, or
a reception via the first group of antenna elements.

18. A method comprising:
determining, at a first apparatus, information related to antenna switching by a second apparatus within a subset of sub-band non-overlapping full duplex (SBFD) patterns of a set of SBFD patterns; and
determining, at least based on the information related to the antenna switching, at least one time point for antenna switching.
